(19) United States
(12) Patent Application Publication
(10) Pub. No.: US 2009/0305873 A1
(43) Pub. Date: Dec. 10, 2009

(54) HONEYCOMB STRUCTURE

(75) Inventors: Kazushige OHNO, Ibi-Gun (JP); Masafumi Kunieda, Ibi-Gun (JP); Takahiko Ido, Ibi-Gun (JP)

Correspondence Address: DITTHAVONG MORI & STEINER, P.C., 918 Prince St., Alexandria, VA, 22314, US

(73) Assignee: IBIDEN CO., LTD., Ogaki-Shi (JP)

(21) Appl. No.: 12/511,075

(22) Filed: Jul. 29, 2009

Related U.S. Application Data
(63) Continuation of application No. PCT/JP2008/059273, filed on May 20, 2008.

(51) Int. Cl. B01J 29/06; B01J 29/072; B01J 29/08; B01J 29/18; B01J 29/40

(52) U.S. Cl. 502/65; 502/66; 502/67

(57) ABSTRACT

A honeycomb structure includes at least one honeycomb unit having a longitudinal direction and including zeolite, an inorganic binder, and walls. The zeolite includes a first zeolite ion-exchanged with at least one of Cu, Mn, Ag, and V and a second zeolite ion-exchanged with at least one of Fe, Ti, and Co. Each wall has first and second surfaces which extend along the longitudinal direction and define a thickness of each wall. A ratio of the first zeolite by weight to a total weight of the first and second zeolites at a center of the thickness of each wall is larger than the ratio of the first zeolite at the first or second surface. A ratio of the second zeolite by weight to the total weight at the first or second surface is larger than the ratio of the second zeolite at the center of the thickness of each wall.

### CROSS-REFERENCE TO RELATED APPLICATIONS

The present application is a continuation application of International application No. PCT/JP2008/059273 filed May 20, 2008, the entire contents of which are hereby incorporated by reference.

### BACKGROUND OF THE INVENTION

1. Field of the Invention

The present invention relates to honeycomb structures.

2. Description of the Related Art

As a conventional system for converting automotive exhaust gases, a selective catalytic reduction (SCR) system is known in which NOx is reduced to nitrogen and water using ammonia through the following reactions:

4NO+4NH₃+O₂→4N₂+6H₂O

6NO₂+8NH₃→7N₂+12H₂O

NO+NO₂+2NH₃→2N₂+3H₂O

As a material for adsorbing ammonia in an SCR system, zeolite is known.

Japanese Laid-Open Patent Application No. 9-103653 discloses a method for converting NOx into innocuous products. The method involves providing an iron-ZSM-5 monolithic structure zeolite having a silica to alumina molar ratio of at least about 10, wherein the iron content is about 1 wt % to 5 wt %, and contacting the zeolite with a NOx-containing workstream in the presence of ammonia at a temperature of at least about 200° C.

WO 2006/137149 A1 discloses a honeycomb structure comprising honeycomb units that contain inorganic particles, inorganic fibers, and/or whiskers, wherein the inorganic particles include one or more kinds of material selected from the group consisting of alumina, silica, zirconia, titania, ceria, mullite, and zeolite.

The contents of the aforementioned documents Japanese Laid-Open Patent Application No. 9-103653 and WO 2006/137149 A1 are hereby incorporated by reference herein in their entirety.

### SUMMARY OF THE INVENTION

According to one aspect of the present invention, a honeycomb structure includes at least one honeycomb unit. The at least one honeycomb unit has a longitudinal direction and includes zeolite, an inorganic binder, and walls. The zeolite includes a first zeolite ion-exchanged with at least one of Cu, Mn, Ag, and V and a second zeolite ion-exchanged with at least one of Fe, Ti, and Co. The walls extend along the longitudinal direction to define through-holes. Each of the walls has first and second surfaces which extend along the longitudinal direction and define a thickness of each of the walls. The honeycomb structure has a ratio of the first zeolite by weight to a total weight of the first zeolite and the second zeolite and a ratio of the second zeolite by weight to the total weight. The ratio of the first zeolite at a center of the thickness of each of the walls is larger than the ratio of the first zeolite at the first surface or the second surface. The ratio of the second zeolite at the first surface or the second surface is larger than the ratio of the second zeolite at the center of the thickness of each of the walls.

### BRIEF DESCRIPTION OF THE DRAWINGS

These and other objects, features and advantages of the invention will be apparent to those skilled in the art from the following detailed description of the invention, when read in conjunction with the accompanying drawings in which:

FIG. 1A shows a perspective view of a honeycomb structure according to an embodiment of the present invention;

FIG. 1B shows a schematic cross section of the honeycomb structure of FIG. 1A taken in the longitudinal direction thereof;

FIG. 2A shows a perspective view of a honeycomb structure according to another embodiment of the present invention; and

FIG. 2B shows a perspective view of a honeycomb unit in the honeycomb structure shown in FIG. 2A.

### DETAILED DESCRIPTION OF THE PREFERRED EMBODIMENTS

Embodiments will now be described with reference to the accompanying drawings, wherein like reference numerals designate corresponding or identical elements throughout the various drawings.

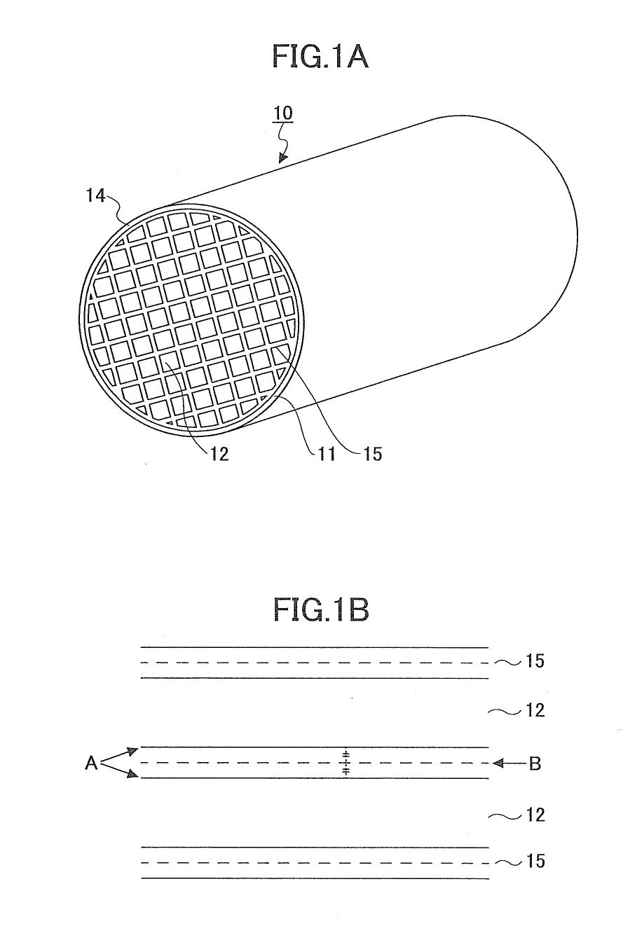

With reference to FIGS. 1A and 1B, a honeycomb structure according to an embodiment of the present invention is described. FIG. 1A shows a perspective view of a honeycomb structure 10. FIG. 1B shows a schematic cross section of the honeycomb structure 10 taken in a longitudinal direction thereof.

As shown in FIG. 1A, the honeycomb structure 10 comprises a single honeycomb unit 11 with a peripheral outer surface thereof coated with an outer coating layer 14. The honeycomb unit 11 contains zeolite and an inorganic binder, and includes plural separating walls 15 formed in the longitudinal direction, defining plural through-holes 12 separated by the separating walls 15.

The zeolite in the honeycomb unit 11 includes a first zeolite ion-exchanged with one or more kinds of metal selected from the group consisting of Cu, Mn, Ag, and V (hereafter referred to as a first zeolite), and a second zeolite ion-exchanged with one or more kinds of metal selected from the group consisting of Fe, Ti, and Co (hereafter referred to as a second zeolite). The zeolite may further include a zeolite that is not ion-exchanged, or a zeolite ion-exchanged with a metal other than those mentioned above.

With reference to FIG. 1B, the ratio of the first zeolite by weight to a total weight of the first and the second zeolites is greater at a center B of the separating wall 15 than in a surface A thereof. The ratio of the second zeolite by weight to the total weight of the first and the second zeolites is greater in the surface A of the separating wall 15 than at the center B thereof.

The “surface” of the separating wall is herein intended to refer to a region of the separating wall near its surface, having an unspecified thickness. The “center” of the separating wall is herein intended to refer to a region of the separating wall near its center, having an unspecified thickness.

When a conventional honeycomb structure having an Fe-ion-exchanged zeolite as a main material is used in an SCR system, the actual conversion rate of the SCR system tends to be lower than an expected NOx conversion rate based on the amount of zeolite contained in the honeycomb structure. This is believed due to a temperature difference between a surface portion and a central portion of the separating wall of the honeycomb structure which is caused when the exhaust gas flows through the honeycomb structure. Namely, the temperature at the central portion of the separating wall becomes relatively low, thus forming a low-temperature region where the Fe-ion-exchanged zeolite cannot exhibit sufficient NOx converting performance.

In accordance with an embodiment of the present invention, a honeycomb structure can be provided whereby, in an SCR system, improved NOx conversion rates can be obtained in a wide temperature range.

The present inventors found that a high NOx conversion performance can be obtained in a wide temperature range by placing the first zeolite in the central portion of the separating wall of the honeycomb structure, while placing the second zeolite in the surface portion of the separating wall. This is believed due to the fact that the first zeolite, which is ion-exchanged with one or more kinds of metal selected from the group consisting of Cu, Mn, Ag, and V, provides higher NOx conversion performance in a low-temperature region (such as at about 150° C. to about 250° C.) than the second zeolite, which is ion-exchanged with one or more kinds of metal selected from the group consisting of Fe, Ti, and Co.

When the honeycomb structure 10 is applied in an SCR system (such as an SCR system in which NOx is reduced to nitrogen and water using ammonia), the surface A of the separating wall 15 tends to experience a relatively high temperature due to the flow of the exhaust gas, while the center B of the separating wall 15 tends to experience a relatively low temperature. Thus, the zeolites placed in the honeycomb unit 11 in accordance with the present embodiment can be effectively utilized for NOx conversion. As a result, improved NOx conversion rates can be obtained in a wide temperature range (such as between about 200° C. and about 500° C.) of the honeycomb structure 10.

In the honeycomb structure 10, the ratio of the first zeolite by weight to the total weight of the first and the second zeolites may be either substantially constant or may vary continuously or discontinuously between the surface A and the center B of the separating wall 15.

As mentioned above, the temperature tends to become higher near the surface A of the separating wall 15 due to the flow of exhaust gas. Thus, the ratio of the second zeolite is preferably increased toward the surface A of the separating wall 15.

Conversely, the temperature tends to be lower near the center B of the separating wall 15 because of its distance from the gas flow. Thus, the ratio of the first zeolite is increased toward the center B of the separating wall 15.

Preferably, in the surface A of the separating wall 15, the ratio of the second zeolite, which is ion-exchanged with one or more kinds of metal selected from the group consisting of Fe, Ti, and Co, by weight to the total weight of the first and the second zeolites is about 0.90 to about 1.00. When this weight ratio is about 0.90 or greater, the zeolites in the surface A of the separating wall 15 can be more effectively utilized for NOx conversion.

Preferably, at the center B of the separating wall 15, the ratio of the first zeolite, which is ion-exchanged with one or more kinds of metal selected from the group consisting of Cu, Mn, Ag, and V, by weight to the total weight of the first and the second zeolites is about 0.90 to about 1.00. When this weight ratio is equal to or greater than about 0.90, the zeolites at the center B of the separating wall 15 can be more effectively used for NOx conversion.

In the honeycomb unit 11, the zeolite content per apparent volume is about 230 g/L to about 270 g/L. When the zeolite content per apparent volume of the honeycomb unit 11 is equal to or greater than about 230 g/L, the apparent volume of the honeycomb unit 11 does not need to be increased in order to obtain a sufficient NOx conversion rate. When the zeolite content is equal to or less than about 270 g/L, a required strength of the honeycomb unit 11 can be more readily obtained. The term “zeolite” is herein intended to refer to the entire zeolites, i.e., both zeolites that are ion-exchanged and zeolites that are not ion-exchanged.

The “apparent volume” of the honeycomb unit is herein intended to refer to the volume of the honeycomb unit including the through-holes.

Preferably, in each of the first and the second zeolites, the ion-exchanged amount is about 1.0 wt % to about 10.0 wt % and more preferably about 1.0 wt % to about 5.0 wt %. When the ion-exchanged amount is equal to or greater than about 1.0 wt %, a sufficient change in ammonia-adsorbing capability due to ion exchange can be more readily obtained. When the ion-exchanged amount is less than about 10.0 wt %, a sufficient structural stability can be more readily obtained upon application of heat. The zeolite may be ion-exchanged by immersing it in an aqueous solution containing a cation.

The kind of the zeolites is not particularly limited; examples are zeolite β, ZSM-5, mordenite, faujasite, zeolite A, and zeolite L, of which two or more kinds may be used in combination. The zeolites herein refer to the entire zeolites.

Preferably, the zeolites have a silica to alumina molar ratio of about 30 to about 50. The zeolites herein refer to the entire zeolites.

Preferably, the zeolites contain secondary particles of which an average particle size is preferably about 0.5 μm to about 10 μm. When the average particle size of the secondary particles of the zeolites is equal to or greater than about 0.5 μm, a large amount of an inorganic binder does not need to be added, resulting in less difficulty in extrusion molding. When the average particle size of the secondary particles of the zeolites is equal to or less than about 10 μm, a sufficient specific surface area of the zeolites can be more readily obtained, resulting in a stable NOx conversion rate. The zeolites herein refer to the entire zeolites.

The honeycomb unit 11 may further include inorganic particles other than zeolites for strength improving purposes. The inorganic particles other than zeolites are not particularly limited. Examples are alumina, silica, titania, zirconia, ceria, mullite, and their precursors, of which two or more may be used in combination. Among those mentioned above, alumina and zirconia are particularly preferable. The zeolites herein refer to the entire zeolites.

Preferably, the inorganic particles other than zeolites have an average particle size of about 0.5 μm to about 10 μm. When the average particle size of the inorganic particles other than zeolites is equal to or greater than about 0.5 μm, a large amount of an inorganic binder does not need to be added, resulting in less difficulty in extrusion molding. When the average particle size of the inorganic particles other than zeolites is equal to or less than about 10 μm, a sufficient strength of the honeycomb unit 11 can be more readily obtained. The inorganic particles other than zeolites may include secondary particles.

Preferably, the ratio of the average particle size of the secondary particles of the inorganic particles other than zeolites to the average particle size of the secondary particles of the zeolites is about 1.0 or less and more preferably about 0.1 to about 1.0. When the ratio is equal to or less than about 1.0, a sufficient effect of improving the strength of the honeycomb unit 11 can be more readily obtained. The zeolites herein refer to the entire zeolites.

Preferably, in the honeycomb unit 11, the content of the inorganic particles other than zeolites is about 3 wt % to about 30 wt % and more preferably about 5 wt % to about 20 wt %. When the content is equal to or greater than about 3 wt %, a sufficient effect of improving the strength of the honeycomb unit 11 can be more readily obtained. When the content of the inorganic particles other than zeolites is equal to or less than about 30 wt %, a sufficient zeolite content in the honeycomb unit 11 can be more readily obtained, resulting in a stable in NOx conversion rate.

The inorganic binder is not particularly limited. Examples are solid contents in an alumina sol, a silica sol, a titania sol, a liquid glass, sepiolite, and attapulgite, of which two or more may be used in combination.

In the honeycomb unit 11, a solid content of the inorganic binder is preferably about 5 wt % to about 30 wt % and more preferably about 10 wt % to about 20 wt %. When the solid content of the inorganic binder is equal to or greater than about 5 wt %, a sufficient strength of the honeycomb unit 11 can be more readily obtained. When the solid inorganic binder content is equal to or less than about 30 wt %, molding of the honeycomb unit becomes less difficult.

The honeycomb unit 11 may further preferably contain inorganic fibers for strength improving purposes. The inorganic fibers are not particularly limited as long as they contribute to the improvement in strength of the honeycomb unit 11. Examples are alumina, silica, silicon carbide, silica alumina, glass, potassium titanate, aluminum borate and the like, of which two or more may be used in combination.

The inorganic fibers preferably have an aspect ratio of about 2 to about 1000, more preferably about 5 to about 800, and even more preferably about 10 to about 500. When the aspect ratio is equal to or greater than two, a sufficient effect of increasing the strength of the honeycomb unit 11 can be more readily obtained. When the aspect ratio is equal to or less than about 1000, the likelihood of clogging or the like in the die decreases during extrusion molding or the like of the honeycomb unit, and the inorganic fibers become less likely to break during molding, thereby ensuring a sufficient effect of increasing the strength of the honeycomb unit 11.

In the honeycomb unit 11, the inorganic fibers content is preferably about 3 wt % to about 50 wt %, more preferably about 3 wt % to about 30 wt %, and even more preferably about 5 wt % to about 20 wt %. When the inorganic fibers content is equal to or greater than about 3 wt %, a sufficient effect of increasing the strength of the honeycomb unit 11 can be more readily obtained. When the inorganic fibers content is equal to or less than about 50 wt %, a sufficient zeolite content in the honeycomb unit 11 can be more readily obtained, so that a sufficient NOx conversion rate can be more readily obtained.

Preferably, the honeycomb unit 11 has a porosity of about 25% to about 40%. When the porosity is equal to or greater than about 25%, exhaust gas can more readily penetrate the separating wall 15, so that the zeolites can be more effectively used for NOx conversion. When the porosity of the honeycomb unit 11 is equal to or less than about 40%, a sufficient effect of improving the strength of the honeycomb unit 11 can be more readily obtained.

Preferably, the honeycomb unit 11 has an opening ratio of about 50% to about 65% in a cross section perpendicular to the longitudinal direction thereof. When the opening ratio is equal to or greater than about 50%, the zeolites can be more effectively used for NOx conversion. When the opening ratio is equal to or less than about 65%, a sufficient strength of the honeycomb unit 11 can be more readily obtained.

In the honeycomb unit 11, preferably the density of the through-holes 12 in a cross section perpendicular to the longitudinal direction of the honeycomb unit 11 is about 31 to about 124 holes/cm². When the density of the through-holes 12 is equal to or greater than about 31 holes/cm², the exhaust gas can more readily come into contact with the zeolites, thus preventing a decrease in NOx conversion performance of the honeycomb unit 11. When the density is equal to or less than about 124 holes/cm², an increase in pressure loss of the honeycomb unit 11 can be more readily prevented.

Preferably, the separating wall 15 of the honeycomb unit 11 has a thickness of about 0.10 mm to about 0.50 mm and more preferably about 0.15 mm to about 0.35 mm. When the thickness of the separating wall 15 is equal to or greater than about 0.10 mm, a sufficient strength of the honeycomb unit 11 can be more readily obtained. When the thickness is equal to or less than about 0.50 mm, the exhaust gas can more readily penetrate the separating wall 15, so that the zeolites can be more effectively used for NOx conversion.

The outer coating layer 14 preferably has a thickness of about 0.1 mm to about 2 mm. When the thickness of the outer coating layer 14 is equal to or greater than about 0.1 mm, a sufficient effect of increasing the strength of the honeycomb structure 10 can be more readily obtained. When the thickness of the outer coating layer 14 is equal to or less than about 2 mm, a sufficient zeolite content per unit volume of the honeycomb unit 11 can be more readily obtained, so that a decrease in NOx conversion performance of the honeycomb structure 10 can be more readily prevented.

The honeycomb structure 10 in accordance with the present embodiment is cylindrical in shape. However, the shape of the honeycomb structure 10 is not particularly limited. For example, the honeycomb structure 10 may be substantially polygonal-pillar shaped, substantially cylindroid-shaped or the like. Further, while the through-holes 12 in accordance with the present embodiment are rectangular-pillar shaped, the shape of the through-hole is not particularly limited. For example, the through-holes 12 may be substantially triangular-pillar shaped, substantially hexagonal-pillar shaped or the like.

Hereafter, a method of manufacturing the honeycomb structure 10 is described. First, there is prepared a raw material paste containing the first zeolite and an inorganic binder. The first zeolite is ion-exchanged with one or more kinds of metal selected from the group consisting of Cu, Mn, Ag, and V. The raw material paste may further contain the second zeolite, inorganic particles other than zeolite, and inorganic fibers or the like, as needed. The second zeolite is ion-exchanged with one or more kinds of metal selected from the group consisting of Fe, Ti, and Co.

The raw material paste is then molded by extrusion molding or the like to obtain a raw cylindrical honeycomb molded body having plural separating walls 15 that extend in the longitudinal direction of the molded body, thus defining through-holes. From the raw cylindrical honeycomb molded body, a cylindrical honeycomb unit 11 having a sufficient strength can be obtained even when the firing temperature is low.

The inorganic binder added in the raw material paste may include an alumina sol, a silica sol, a titania sol, a liquid glass, sepiolite, or attapulgite or the like, of which two or more may be used in combination.

The raw material paste may further contain an organic binder, a dispersion medium, a forming aid or the like as needed.

The organic binder is not particularly limited. Examples are methylcellulose, carboxymethylcellulose, hydroxyethyl cellulose, polyethyleneglycol, phenol resin, epoxy resin and the like, of which two or more may be used in combination. Preferably, the amount of the organic binder added is about 1% to about 10% of the total weight of the zeolites, the inorganic particles other than zeolites, the inorganic fibers, and the inorganic binder. The zeolites herein refer to the entire zeolites.

The dispersion medium is not particularly limited. Examples are water, an organic solvent such as benzene, alcohol such as methanol, and the like, of which two or more may be used in combination.

The forming aid is not particularly limited. Examples are ethylene glycol, dextrin, aliphatic acid, aliphatic acid soap, polyalcohol, and the like, of which two or more may be used in combination.

When preparing the raw material paste, the raw material paste is preferably mixed and kneaded using a mixer, an attritor, a kneader or the like, for example.

The obtained honeycomb molded body is then dried using a drying apparatus, such as a microwave drying apparatus, a hot-air drying apparatus, a dielectric drying apparatus, a reduced-pressure drying apparatus, a vacuum drying apparatus, or a freeze-drying apparatus.

The dried honeycomb molded body is further degreased under conditions that are not particularly limited and may be selected appropriately depending on the kind or amount of organic matter contained in the molded body. Preferably, the honeycomb molded body is degreased at about 400° C. for about two hours.

The degreased honeycomb molded body is then fired, obtaining the cylindrical honeycomb unit 11. The firing temperature is preferably about 600° C. to about 1200° C. and more preferably about 600° C. to about 1000° C. When the firing temperature is equal to or greater than about 600° C., sintering can proceed more readily and a sufficient strength of the honeycomb unit 11 can be more readily obtained. When the firing temperature is equal to or less than about 1200° C., excessive sintering can be prevented, so that that a decrease in the reactive sites in the zeolite in the honeycomb unit 11 can be prevented.

Thereafter, the outer peripheral surface of the cylindrical honeycomb unit 11 is coated with an outer coating layer paste. The outer coating layer paste is not particularly limited. Examples are a mixture of an inorganic binder and inorganic particles, a mixture of an inorganic binder and inorganic fibers, and a mixture of an inorganic binder, inorganic particles, and inorganic fibers, and the like.

The outer coating layer paste may contain an organic binder that is not particularly limited. Examples are polyvinyl alcohol, methylcellulose, ethylcellulose, and carboxymethylcellulose, of which two or more may be used in combination.

The honeycomb unit 11 coated with the outer coating layer paste is then dried and solidified, obtaining a cylindrical honeycomb structure. The cylindrical honeycomb structure is preferably degreased when the outer coating layer paste contains the organic binder. The degreasing condition may be appropriately selected depending on the kind or amount of organic matter contained in the paste. Preferably, degreasing is performed at about 700° C. for about 20 minutes.

The surfaces of the separating walls 15 of the resultant honeycomb structure are then coated with a coating layer by impregnation, for example, thereby obtaining the honeycomb structure 10. The coating layer may be formed using a dispersion liquid containing the second zeolite and the inorganic binder. The dispersion liquid may further contain the first zeolite, inorganic particles other than zeolites, and inorganic fibers, as needed.

The honeycomb structure 10 may also be manufactured by preparing the raw cylindrical honeycomb molded body by double extrusion molding of two kinds of raw material paste having different ratios of the first zeolite to the second zeolite.

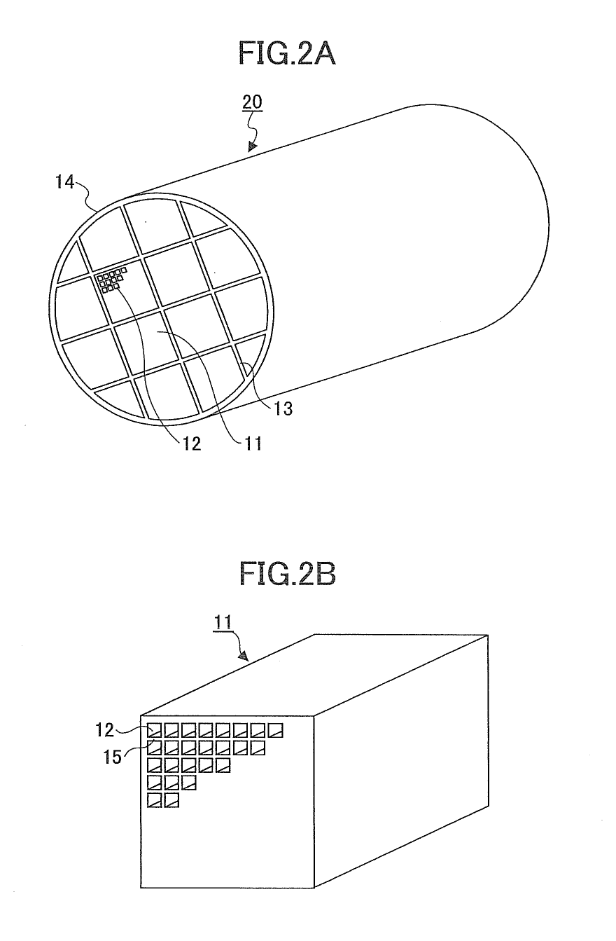

FIGS. 2A and 2B show a honeycomb structure 20 according to other embodiment of the present invention. The honeycomb structure 20 is similar to the honeycomb structure 10 of the foregoing embodiment, with the exception that a plurality of the honeycomb units 11 are joined by interposing bonding layers 13. Each of the honeycomb units 11 has the plural separating walls 15 that extend in the longitudinal direction of the honeycomb structure 20, thus defining the through-holes 12.

Preferably, the individual honeycomb unit 11 has a cross-sectional area of about 5 cm² to about 50 cm² in a cross section perpendicular to the longitudinal direction of the honeycomb unit 11. When the cross-sectional area of the honeycomb unit is equal to or greater than about 5 cm², a sufficient specific surface area of the honeycomb structure 20 can be more readily obtained, and an increase in pressure loss can be prevented. When the cross-sectional area of the honeycomb unit is equal to or less than about 50 cm², a sufficient strength against the thermal stress produced in the honeycomb unit 11 can be more readily obtained.

Preferably, the bonding layer 13 for bonding the honeycomb units 11 has a thickness of about 0.5 mm to about 2 mm. When the thickness of the bonding layer 13 is equal to or greater than about 0.5 mm, a sufficient bonding strength can be more readily obtained. When the thickness of the bonding layer 13 is equal to or less than about 2 mm, a sufficient specific surface area of the honeycomb structure 20 can be more readily obtained, and an increase in pressure loss can be prevented.

Although the honeycomb unit 11 in accordance with the present embodiment shown in FIG. 2B is rectangular-pillar shaped, the shape of the honeycomb unit 11 is not particularly limited. For example, the individual honeycomb units 11 may have a shape that facilitates their joining, such as a substantially hexagonal-pillar shape.

Hereafter, a method of manufacturing the honeycomb structure 20 is described. First, as in the case of the honeycomb structure 10 of the foregoing embodiment, the substantially rectangular-pillar shaped honeycomb unit 11 is manufactured. Then, the outer peripheral surface of the honeycomb unit 11 is coated with the bonding layer paste, and the individual honeycomb units 11 are successively joined. The joined honeycomb units 11 are then dried and solidified, obtaining a honeycomb unit assembly. Thereafter, the honeycomb unit assembly may be cut to a cylindrical shape and then polished. Alternatively, the honeycomb units 11 having substantially sectoral or substantially square cross sections may be joined to obtain the cylindrical honeycomb unit assembly.

The bonding layer paste is not particularly limited. Examples of the bonding layer paste include a mixture of an inorganic binder and inorganic particles; a mixture of an inorganic binder and inorganic fibers; and a mixture of an inorganic binder, inorganic particles, and inorganic fibers.

The bonding layer paste may also contain an organic binder. The organic binder may include but is not limited to polyvinyl alcohol, methylcellulose, ethylcellulose, and carboxymethylcellulose, of which two or more may be used in combination.

Thereafter, the outer peripheral surface of the cylindrical honeycomb unit assembly is coated with the outer coating layer paste. The outer coating layer paste is not particularly limited, and it may contain the same material as or a different material from the bonding layer paste. The outer coating layer paste may have the same composition as the bonding layer paste.

The honeycomb unit assembly thus coated with the outer coating layer paste is then dried and solidified, thereby obtaining a cylindrical honeycomb structure. Preferably, the cylindrical honeycomb structure is degreased when the bonding layer paste and/or the outer coating layer paste contains the organic binder. Degreasing conditions may be appropriately selected depending on the kind or amount of organic matter. Preferably, however, degreasing is performed at about 700° C. for about 20 minutes.

The surfaces of the separating walls 15 of the obtained honeycomb structure are then coated with the coating layer in the same way as in the honeycomb structure 10, thereby obtaining the honeycomb structure 20.

Alternatively, the honeycomb structure 20 may be manufactured by preparing the raw rectangular-pillar shaped honeycomb unit 11 by double extrusion of two kinds of raw material paste having different ratios of the first zeolite, which is ion-exchanged with one or more kinds of metal selected from the group consisting of Cu, Mn, Ag, and V, to the second zeolite, which is ion-exchanged with one or more kinds of metal selected from the group consisting of Fe, Ti, and Co.

The outer coating layer may or may not be formed on the honeycomb structure according to an embodiment of the present invention.

### Example 1

A raw material paste was obtained by mixing and kneading 2600 g of zeolite β ion-exchanged with Cu by 3 wt % and having an average particle size of 2 μm, a silica to alumina ratio (silica/alumina) of 40, and a specific surface area of 110 m²/g, 2600 g of alumina sol as an inorganic-binder-containing component having a solid content of 20 wt %, 780 g of alumina fibers as inorganic fibers having an average fiber diameter of 6 μm and an average fiber length of 100 μm, and 410 g of methylcellulose as an organic binder. The zeolite had been ion-exchanged with Cu by impregnating zeolite particles with an aqueous solution of copper nitrate. The amount of ion-exchanged zeolite was determined by ICP emission spectrometry using the ICPS-8100 spectrometer from Shimadzu Corporation.

The raw material paste was then extrusion-molded by an extrusion molding machine, obtaining a raw cylindrical honeycomb molded body. The raw cylindrical honeycomb molded body was then dried using a microwave drying apparatus and a hot-air drying apparatus, followed by degreasing at 400° C. for 2 hours. Thereafter, firing was performed at 700° C. for 2 hours, thereby manufacturing a cylindrical honeycomb structure measuring 30 mm in diameter and 50 mm in length.

The resultant honeycomb structure was impregnated with a coating layer dispersion liquid with a solid content of 35 wt %. The coating layer dispersion liquid had dispersed therein 82.5 parts by weight of zeolite β and 17.5 parts by weight of an alumina sol having a solid content of 20 wt %. The zeolite β had been ion-exchanged with Fe by 3 wt % and had an average particle size of 2 μm, a silica to alumina ratio of 40, and a specific surface area of 110 m²/g. Thereafter, the honeycomb structure was maintained at 600° C. for 1 hour, thereby forming the coating layer on the separating walls of the honeycomb structure. The Fe-ion exchange had been performed by impregnating zeolite particles with a solution of iron ammonium nitrate.

The obtained honeycomb structure had an opening ratio of 60% in a cross section perpendicular to the longitudinal direction thereof, a through-hole density of 93 holes/cm², a separating wall thickness of 0.10 mm, a zeolite content of 250 g/L per apparent volume, and a porosity of 30% (see Table 1).

The opening ratio was determined by calculating the area of the through-holes in a 10×10 cm area of the honeycomb structure using an optical microscope. The density of the through-holes was determined by measuring the number of the through-holes in a 10×10 cm area of the honeycomb structure by optical microscope. For the thickness of the separating wall, an average value was obtained by measuring the thickness of the separating walls at five locations by optical microscope. The porosity was determined by mercury intrusion method.

### Examples 2 and 3

Honeycomb structures according to Examples 2 and 3 were manufactured in the same way as for Example 1 with the exception that the structure of the die of the extrusion molding machine was changed, followed by forming the coating layer on the separating walls (see Table 1).

### Comparative Example 1

A raw material paste was obtained by mixing and kneading 2600 g of zeolite β ion-exchanged with Fe by 3 wt % and having an average particle size of 2 μm, a silica to alumina ratio of 40, and a specific surface area of 110 m²/g, 2600 g of alumina sol with a solid content of 20 wt % as an inorganic-binder-containing component, 780 g of alumina fibers as inorganic fibers having an average fiber diameter of 6 μm and an average fiber length of 100 μm, and 410 g of methylcellulose as an organic binder.

The raw material paste was then extrusion-molded with an extrusion molding machine, obtaining a raw honeycomb molded body. The honeycomb molded body was then dried with a microwave drying apparatus and a hot-air drying apparatus, followed by degreasing at 400° C. for 2 hours. Firing was then performed at 700° C. for 2 hours, thereby manufacturing a cylindrical honeycomb structure measuring 30 mm in diameter and 50 mm in length (see Table 1).

TABLE 1

| | | | | | Cu ion- | Fe ion- | | |
|---|---|---|---|---|---|---|---|---|
| | Thickness of | Density of | Opening | | exchanged | exchanged | NOx conversion | |
| | separating wall | through-holes | ratio | Porosity | zeolite content | zeolite content | rate (%) | |
| | (mm) | (/cm²) | (%) | (%) | (g/L) | (g/L) | 200° C. | 500° C. |
| Ex. 1 | 0.10 | 93 | 60 | 30 | 125 | 125 | 70 | 97 |
| Ex. 2 | 0.12 | 62 | 60 | 30 | 125 | 125 | 70 | 97 |
| Ex. 3 | 0.14 | 42 | 60 | 30 | 125 | 125 | 70 | 96 |
| Com. Ex. 1 | 0.25 | 62 | 60 | 30 | 0 | 250 | 45 | 98 |

### Measurement of NOx Conversion Rate

While simulation gas at temperatures of 200° C. and 500° C. was caused to flow through the honeycomb structures according to Examples 1 to 3 and Comparative Example 1 at a space velocity (SV) of 35000/hr, the amount of nitric oxide (NO) at the outlet of the honeycomb structure was measured, using the MEXA-7100D exhaust gas analyzer from HORIBA, Ltd. The NOx conversion rate (%) was measured (detection limit: 0.1 ppm) according to the following expression:

$$\frac{NO inflow - NO outflow}{NO inflow} \times 100$$

The constituent components of the simulation gas were nitrogen (balance), carbon dioxide (5% by volume), oxygen (14% by volume), nitric oxide (350 ppm), ammonia (350 ppm), and water (5% by volume). The result of measurement is shown in Table 1. It can be seen from Table 1 that the honeycomb structures of Examples 1 to 3 provide higher NOx conversion rates than the honeycomb structure of Comparative Example 1 at 200° C. to 500° C.

Thus, improved NOx conversion rates can be obtained in a wide temperature range by the honeycomb structures according to the embodiments of the present invention, in which the ratio of the first zeolite by weight to the total weight of the first zeolite and the second zeolite is higher at the center of the separating wall than in the surface thereof, and the ratio of the second zeolite by weight to the total weight of the first and the second zeolites is higher in the surface of the separating wall than at the center of the separating wall.

Although this invention has been described in detail with reference to certain embodiments, variations and modifications exist within the scope and spirit of the invention as described and defined in the following claims.

What is claimed is:

1. A honeycomb structure comprising:
at least one honeycomb unit having a longitudinal direction and comprising:
zeolite comprising a first zeolite ion-exchanged with at least one of Cu, Mn, Ag, and V and a second zeolite ion-exchanged with at least one of Fe, Ti, and Co;
an inorganic binder; and
walls extending along the longitudinal direction to define through-holes, each of the walls having first and second surfaces which extend along the longitudinal direction and define a thickness of each of the walls;
a ratio of the first zeolite by weight to a total weight of the first zeolite and the second zeolite at a center of the thickness of each of the walls being larger than a ratio of the first zeolite by weight to the total weight at the first surface or the second surface; and
a ratio of the second zeolite by weight to the total weight at the first surface or the second surface being larger than a ratio of the second zeolite by weight to the total weight at the center of the thickness of each of the walls.

2. The honeycomb structure according to claim 1, wherein the ratio of the first zeolite by weight to the total weight of the first and second zeolites at the center is from about 0.90 to about 1.00.

3. The honeycomb structure according to claim 1, wherein the ratio of the second zeolite by weight to the total weight of the first and second zeolites at the first or second surface is from about 0.90 to about 1.00.

4. The honeycomb structure according to claim 1, wherein the at least one honeycomb unit comprises the zeolite in an amount from about 230 g/L to about 270 g/L per apparent volume of the at least one honeycomb unit.

5. The honeycomb structure according to claim 1, wherein each of the first and second zeolites comprises at least one of zeolite β, zeolite Y, ferrierite, ZSM-5 zeolite, mordenite, faujasite, zeolite A, and zeolite L.

6. The honeycomb structure according to claim 1, wherein each of the first and second zeolites has a silica to alumina molar ratio from about 30 to about 50.

7. The honeycomb structure according to claim 1, wherein each of the first and second zeolites independently has secondary particles having an average particle size from about 0.5 μm to about 10 μm.

8. The honeycomb structure according to claim 1, wherein the at least one honeycomb unit further comprises inorganic particles other than zeolites.

9. The honeycomb structure according to claim 8, wherein the inorganic particles other than zeolites comprise at least one of alumina, silica, titania, zirconia, ceria, mullite, and their precursors.

10. The honeycomb structure according to claim 1, wherein the inorganic binder comprises a solid content contained in at least one of alumina sol, silica sol, titania sol, liquid glass, sepiolite, and attapulgite.

11. The honeycomb structure according to claim 1, wherein the at least one honeycomb unit further comprises inorganic fibers.

12. The honeycomb structure according to claim 11, wherein the inorganic fibers comprise at least one of alumina, silica, silicon carbide, silica alumina, glass, potassium titanate, and aluminum borate.

13. The honeycomb structure according to claim 1, wherein the at least one honeycomb unit has a porosity from about 25% to about 40%.

14. The honeycomb structure according to claim 1, wherein the at least one honeycomb unit has an opening ratio from about 50% to about 65% in a cross section perpendicular to the longitudinal direction of the at least one honeycomb unit.

15. The honeycomb structure according to claim 1, wherein the at least one honeycomb unit comprises a plurality of honeycomb units which are bonded by interposing a bonding layer.

16. The honeycomb structure according to claim 1, wherein the honeycomb structure comprises a single honeycomb unit.

17. The honeycomb structure according to claim 1, wherein the ratio of the first zeolite by weight to the total weight of the first zeolite and the second zeolite is substantially constant in an area extending between the first or second surface of each wall and the center of the thickness thereof.

18. The honeycomb structure according to claim 1, wherein the ratio of the first zeolite by weight to the total weight of the first zeolite and the second zeolite varies continuously in an area extending between the first or second surface of each wall and the center of the thickness thereof.

19. The honeycomb structure according to claim 1, wherein the ratio of the first zeolite by weight to the total weight of the first zeolite and the second zeolite varies discontinuously in an area extending between the first or second surface of each wall and the center of the thickness thereof.

20. The honeycomb structure according to claim 1, wherein the ratio of the second zeolite varies so as to become larger along a direction from the center of the thickness of each wall toward the first or second surface thereof.

21. The honeycomb structure according to claim 1, wherein the ratio of the first zeolite varies so as to become larger along a direction from the first or second surface of each wall toward the center of the thickness thereof.

22. The honeycomb structure according to claim 1, wherein an ion-exchanged amount of each of the first zeolite and the second zeolite is from about 1.0 wt % to about 10.0 wt %.

23. The honeycomb structure according to claim 8, wherein the inorganic particles other than zeolites have an average particle size from about 0.5 μm to about 10 μm.

24. The honeycomb structure according to claim 8, wherein the inorganic particles other than zeolites have secondary particles thereof.

25. The honeycomb structure according to claim 8, wherein a ratio of an average particle size of secondary particles of the inorganic particles other than zeolites to an average particle size of secondary particles of the zeolites is equal to or less than about 1.0.

26. The honeycomb structure according to claim 8, wherein a content of the inorganic particles other than zeolites in the at least one honeycomb unit is from about 3 wt % to about 30 wt %.

27. The honeycomb structure according to claim 1, wherein a solid content of the inorganic binder in the at least one honeycomb unit is from about 5 wt % to about 30 wt %.

28. The honeycomb structure according to claim 11, wherein an aspect ratio of the inorganic fibers is from about 2 to about 1000.

29. The honeycomb structure according to claim 11, wherein the at least one honeycomb unit comprises the inorganic fiber in an amount from about 3 wt % to about 50 wt %.

30. The honeycomb structure according to claim 1, wherein a density of the through-holes in a cross section perpendicular to the longitudinal direction of the at least one honeycomb unit is from about 31 holes/cm² to about 124 holes/cm².

31. The honeycomb structure according to claim 1, wherein the thickness of each of the walls is from about 0.10 mm to about 0.50 mm.

32. The honeycomb structure according to claim 15, wherein each of the plurality of honeycomb units has a cross-sectional area from about 5 cm² to about 50 cm² in a cross section perpendicular to the longitudinal direction.

33. The honeycomb structure according to claim 15, wherein the honeycomb structure is produced by cutting an outer peripheral surface of the plurality of honeycomb units.

34. The honeycomb structure according to claim 15, wherein the plurality of honeycomb units comprise a honeycomb unit having a substantially sectoral shape or a substantially square shape in a cross section perpendicular to the longitudinal direction.

35. The honeycomb structure according to claim 1, wherein the honeycomb structure is so constructed to be used for NOx conversion.

36. The honeycomb structure according to claim 35, wherein the honeycomb structure is so constructed to be used in an SCR system.
